(19) United States
(12) Patent Application Publication
(10) Pub. No.: US 2015/0063836 A1
(43) Pub. Date: Mar. 5, 2015

(54) Fuser Member Conditioning Systems and Methods

(71) Applicant: Lexmark International, Inc., Lexington, KY (US)

(72) Inventors: Fangsheng Wu, Lexington, KY (US); Benjamin Karnik Johnson, Lexington, KY (US); Charles Scott McDavid, Frankfort, KY (US); Jennifer Lyn Gordon, Lexington, KY (US)

(73) Assignee: Lexmark International, Inc., Lexington, KY (US)

(21) Appl. No.: 14/013,218

(22) Filed: Aug. 29, 2013

(51) Int. Cl. G03G 15/20; G03G 13/20

(52) U.S. Cl. CPC G03G 15/2039; G03G 13/20
USPC 399/21; 399/328; 399/43

(57) ABSTRACT

Disclosed is a method of conditioning a fusing member having a top-release layer. The method includes heating the top-release layer to at least the melting temperature of the top-release layer while rotating the fusing member and while no pressure member engages the top-release layer, and cooling the top-release layer to less than the melting temperature of the top-release layer while rotating the fusing member. Other methods and devices are disclosed.

### CROSS REFERENCES TO RELATED APPLICATIONS

None.

### BACKGROUND

1. Field of the Disclosure

The present disclosure relates generally to systems used to fuse toner in image forming devices and, more particularly, to systems and methods of conditioning a fuser member used to fuse toner.

2. Description of the Related Art

In the electrophotographic (EP) print process an image is exposed on a photo-conductor, toner is attracted to the exposed image, and toner is deposited on media. The toner is made of plastic particles which must be heated and pressed to permanently fuse the toner to the media. Devices which perform this fusing are known as fusers.

Fusers typically have a top-release layer that contacts the toner and the media. The top-release layer is designed so that toner does not cling to the fuser and instead remains on the media. Over time, the top-release layer will wear due to contact with the media. Worn fusers have reduced gloss which creates print defects.

Fusers may be internally heated or externally heated. Externally heated fusers use a lamp to heat the top-release layer. In unusual conditions, such as during a paper jam, the lamp may heat unevenly due to media partially blocking the top-release layer. This may cause the top-release layer to flow and create a gloss band at the edge of the media. The gloss band may cause print defects on subsequent pages.

Accordingly, it will be appreciated that it is desirable to condition a fuser's top-release layer to restore it to uniform gloss.

### SUMMARY

Provided is a method of operating an image forming device. The image forming device includes a fusing member having a top-release layer and a pressure member configured to engage the top-release layer. The method includes disengaging the pressure member from the top-release layer, heating the top-release layer to at least the melting temperature of the top-release layer while rotating the fusing member with the pressure member disengaged from the top-release layer, cooling the top-release layer to less than the melting temperature of the top-release layer while rotating the fusing member with the pressure member disengaged from the roller surface coating, and reengaging the pressure member with the top-release layer.

Also provided is a method of conditioning a fusing member having a top-release layer. The method includes heating the top-release layer to at least the melting temperature of the top-release layer while rotating the fusing member and while no pressure member engages the top-release layer, and cooling the top-release layer to less than the melting temperature of the top-release layer while rotating the fusing member.

Also provided is an image forming device having a fusing member having a top-release layer, a pressure member configured to engage with the top-release layer to press media against the top-release layer, and a controller. The controller is configured to condition the top-release layer by disengaging the pressure member from the top-release layer, heating the top-release layer to at least the melting temperature of the top-release layer while rotating the fusing member with the pressure member disengaged from the top-release layer, cooling the top-release layer to less than the melting temperature of the top-release layer with the pressure member disengaged from the top-release layer, and reengaging the pressure member with the top-release layer.

### BRIEF DESCRIPTION OF THE DRAWINGS

The above-mentioned and other features and advantages of the various embodiments, and the manner of attaining them, will become more apparent and will be better understood by reference to the accompanying drawings.

FIG. 1 is a block diagram of an imaging system according to one example embodiment.

FIGS. 2 and 3 are diagrams of the fuser shown in FIG. 1 according to one example embodiment. In FIG. 2, a top-release layer is in contact with a belt. In FIG. 3, the top-release layer is not in contact with the belt.

FIG. 4 is a flowchart of a method of conditioning a fusing member according to one example embodiment.

FIG. 5 is a flowchart of a method of operating an image forming device according to another example embodiment.

### DETAILED DESCRIPTION

The following description and drawings illustrate embodiments sufficiently to enable those skilled in the art to practice the present invention. It is to be understood that the disclosure is not limited to the details of construction and the arrangement of components set forth in the following description or illustrated in the drawings. The invention is capable of other embodiments and of being practiced or carried out in various ways. For example, other embodiments may incorporate structural, chronological, electrical, process, and other changes. Examples merely typify possible variations. Individual components and functions are optional unless explicitly required, and the sequence of operations may vary. Portions and features of some embodiments may be included in or substituted for those of others. The scope of the application encompasses the appended claims and all available equivalents. The following description is, therefore, not to be taken in a limited sense and the scope of the present invention is defined by the appended claims.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top”, “bottom”, “front”, “back”, “rear” and “side” “under”, “below”, “lower”, “over”, “upper”, and the like, are used for ease of description to explain the positioning of one element relative to a second element. These terms are generally used in reference to the position of an element in its intended operational position within an image forming device. Further, terms such as “first”, “second”, and the like, are used to describe various elements, regions, sections, etc. and are not intended to be limiting. Like terms refer to like elements throughout the description.

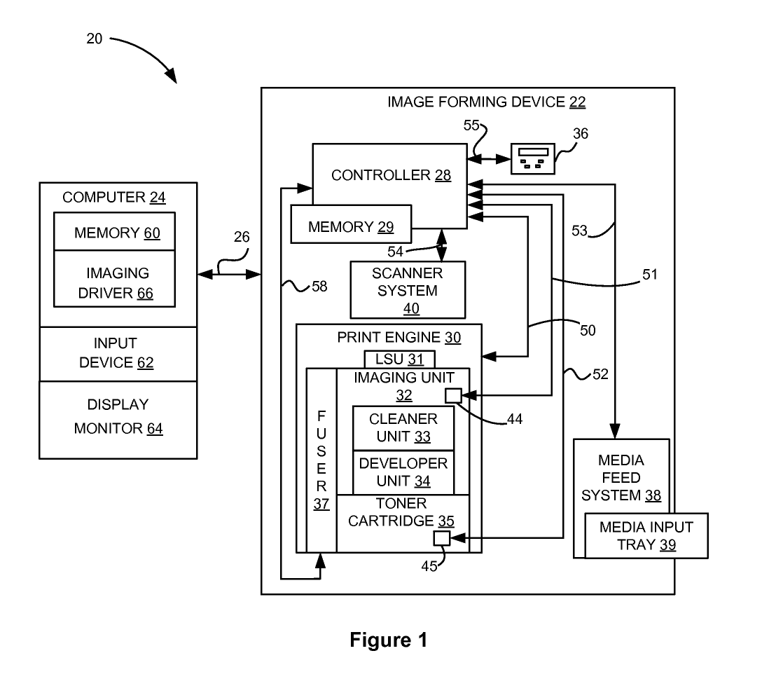

Referring now to the drawings and particularly to FIG. 1, there is shown a block diagram depiction of an imaging system 20 according to one example embodiment. Imaging system 20 includes an image forming device 22 and a computer 24. Image forming device 22 communicates with computer 24 via a communications link 26. As used herein, the term “communications link” generally refers to any structure that facilitates electronic communication between multiple components and may operate using wired or wireless technology and may include communications over the Internet.

In the example embodiment shown in FIG. 1, image forming device 22 is a multifunction machine (sometimes referred to as an all-in-one (AIO) device) that includes a controller 28, a print engine 30, a laser scan unit (LSU) 31, an imaging unit 32, a toner cartridge 35, a user interface 36, a media feed system 38, a media input tray 39 and a scanner system 40. Image forming device 22 may communicate with computer 24 via a standard communication protocol, such as, for example, universal serial bus (USB), Ethernet or IEEE 802.xx. Image forming device 22 may be, for example, an electrophotographic printer/copier including an integrated scanner system 40 or a standalone electrophotographic printer.

Controller 28 includes a processor unit and associated memory 29 and may be formed as one or more Application Specific Integrated Circuits (ASICs). Memory 29 may be any volatile or non-volatile memory or combination thereof such as, for example, random access memory (RAM), read only memory (ROM), flash memory and/or non-volatile RAM (NVRAM). Alternatively, memory 29 may be in the form of a separate electronic memory (e.g., RAM, ROM, and/or NVRAM), a hard drive, a CD or DVD drive, or any processing device convenient for use with controller 28. Controller 28 may be, for example, a combined printer and scanner controller.

In the example embodiment illustrated, controller 28 communicates with print engine 30 via a communications link 50. Controller 28 communicates with imaging unit 32 and processing circuitry 44 thereon via a communications link 51. Controller 28 communicates with toner cartridge 35 and processing circuitry 45 therein via a communications link 52. Controller 28 communicates with media feed system 38 via a communications link 53. Controller 28 communicates with scanner system 40 via a communications link 54. Controller 28 communicates with fuser 37 via a communications link 58. User interface 36 is communicatively coupled to controller 28 via a communications link 55. Processing circuitry 44, 45 may provide authentication functions, safety and operational interlocks, operating parameters and usage information related to imaging unit 32 and toner cartridge 35, respectively. Controller 28 processes print and scan data and operates print engine 30 during printing and scanner system 40 during scanning.

Computer 24, which is optional, may be, for example, a personal computer, network server, tablet computer, smartphone, or other hand-held electronic device including memory 60, such as volatile and/or nonvolatile memory, an input device 62, such as a keyboard and/or a mouse, and a display 64, such as a monitor. Computer 24 also includes a processor, input/output (I/O) interfaces, and may include at least one mass data storage device, such as a hard drive, a CD-ROM and/or a DVD unit (not shown).

Computer 24 includes in its memory 60 a software program including program instructions that function as an imaging driver 66, e.g., printer/scanner driver software, for image forming device 22. Imaging driver 66 is in communication with controller 28 of image forming device 22 via communications link 26. Imaging driver 66 facilitates communication between image forming device 22 and computer 24. One aspect of imaging driver 66 may be, for example, to provide formatted print data to image forming device 22, and more particularly to print engine 30, to print an image. Another aspect of imaging driver 66 may be, for example, to facilitate collection of scanned data from scanner system 40.

In some circumstances, it may be desirable to operate image forming device 22 in a standalone mode. In the standalone mode, image forming device 22 is capable of functioning without computer 24. Accordingly, all or a portion of imaging driver 66, or a similar driver, may be located in controller 28 of image forming device 22 so as to accommodate printing and/or scanning functionality when operating in the standalone mode.

Print engine 30 includes laser scan unit (LSU) 31, toner cartridge 35, imaging unit 32, and a fuser 37, all mounted within image forming device 22. Imaging unit 32 includes a developer unit 34 that houses a toner sump and a toner delivery system. The toner delivery system includes a toner adder roll that provides toner from the toner sump to a developer roll. A doctor blade provides a metered uniform layer of toner on the surface of the developer roll. Imaging unit 32 also includes a cleaner unit 33 that houses a photoconductive drum and a waste toner removal system.

The electrophotographic imaging process is well known in the art and, therefore, will be briefly described. During an imaging operation, laser scan unit 31 creates a latent image on the photoconductive drum in cleaner unit 33. Toner is transferred from the toner sump in developer unit 34 to the latent image on the photoconductive drum by the developer roll to create a toned image. The toned image is then transferred to a media sheet received in imaging unit 32 from media input tray 39. Next, the toned image is fused to the media sheet in fuser 37 and sent to an output location or to one or more finishing options such as a duplexer, a stapler or a hole-punch. Toner remnants are removed from the photoconductive drum by the waste toner removal system housed within cleaner unit 33. As toner is depleted from developer unit 34, toner is transferred from toner cartridge 35 into developer unit 34. Controller 28 provides for the coordination of these activities occurring during the imaging process.

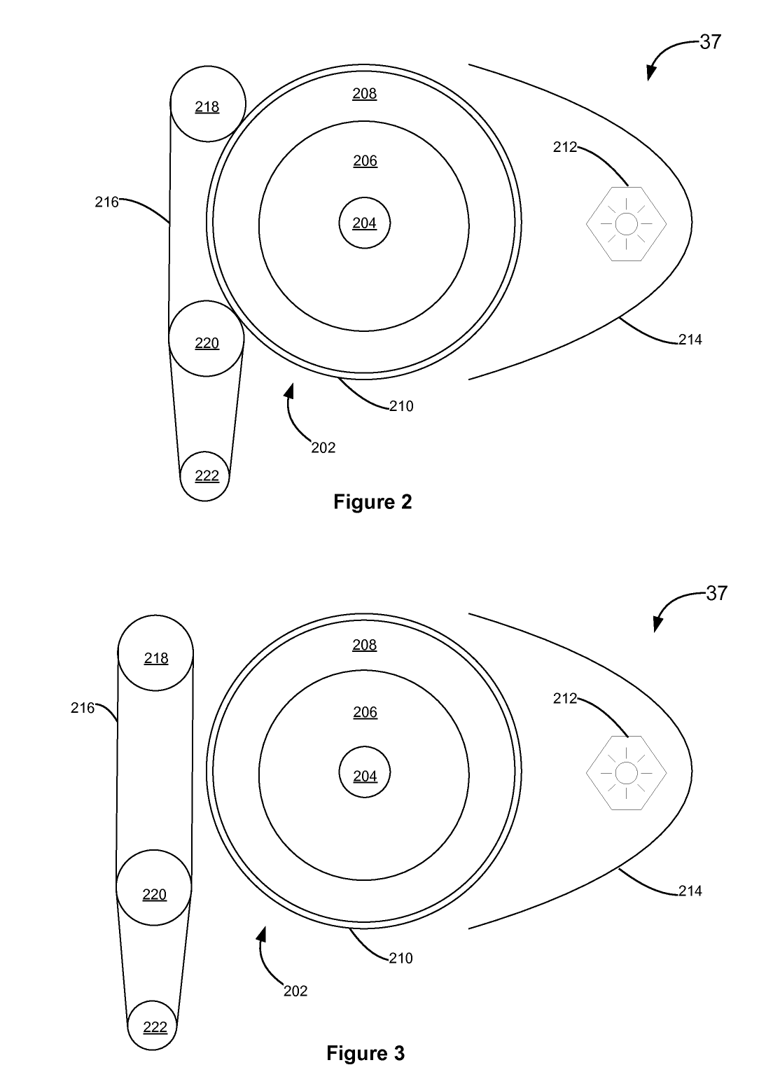

FIG. 2 shows components of fuser 37 according to one example embodiment. Fusing member 202 has a shaft 204 supported by a printer frame (not shown). Shaft 204 is encircled by a rigid core 206, by a flexible support layer 208, and by a top-release layer 210. Top-release layer 210 contains, for example, perfluoroalkoxy (PFA). A heat transport layer (not shown) is located between the top-release layer 210 and the flexible support layer 208. Shaft 204 is rotatably coupled to a motor (not shown).

A lamp 212 is positioned adjacent to top-release layer 210 to heat top-release layer 210 for fusing toner. A reflector 214 directs heat from lamp 212 to top-release layer 210. In this example, the fuser is an externally heated fuser since the heating element, lamp 212, is external to the fusing member 202. By contrast, internally heated fusers contain a heating element located within a fusing member.

In FIG. 2, a belt 216 is pressed against top-release layer 210 by roller 218 and roller 220. Roller 222 provides tension in belt 216. In operation, toner is fused onto media by passing the media between belt 216 and top-release layer 210 while rotating fusing member 202. During fusing, heat is transferred from top-release layer 210 to the toner while pressure is applied to the toner by belt 216 acting as a pressure member. Note that, in other embodiments, a roller may act as a pressure member to apply pressure to toner.

In FIG. 3, roller 218, roller 220, roller 222, and belt 216 are disengaged from top-release layer 210. Mechanisms to provide this translation are well known in the art and include, for example, solenoids, rack-and-pinions, cams, etc. It is advantageous to disengage belt 216 from top-release layer 210 during fuser conditioning, as is described below.

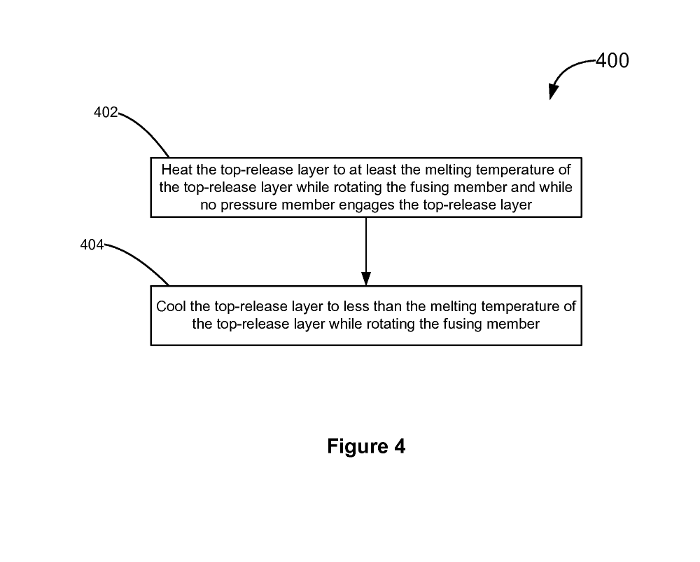

FIG. 4 shows an example embodiment of a method 400 of conditioning a fusing member having a top-release layer using the present invention. The method of conditioning a fusing member restores uniform gloss to the top-release layer. This method may be employed, for example, after the top-release layer has become worn and causes print defects on the fused media. The method utilizes an image forming device that has been configured to disengage one or more pressure members from a fusing-member top-release layer.

At block 402, the method 400 heats the top-release layer to at least the melting temperature of the top-release layer while rotating the fusing member and while no pressure member engages the top-release layer. Heating the top-release layer to at least its melting temperature causes it to flow and heal gloss imperfections such as scratches. Since, at block 402, no pressure member engages the top-release layer, the top-release layer is free to flow without disturbance from pressure members. Such disturbances may create non-uniformities in the top-release layer which may cause print defects.

At block 404, the method 400 cools the top-release layer to less than the melting temperature of the top-release layer while rotating the fusing member. Rotating the fusing member prevents the top-release layer from sagging due to gravity.

The inventors have found that, for a top-release layer that contains perfluoroalkoxy, good results were achieved by heating the top-release layer to between 310 and 325 degrees Celsius, inclusive, for between 30 and 180 seconds, inclusive. Optimum results were achieved by heating the top-release layer to between 315 and 320 degrees Celsius, inclusive, for between 60 and 90 seconds, inclusive.

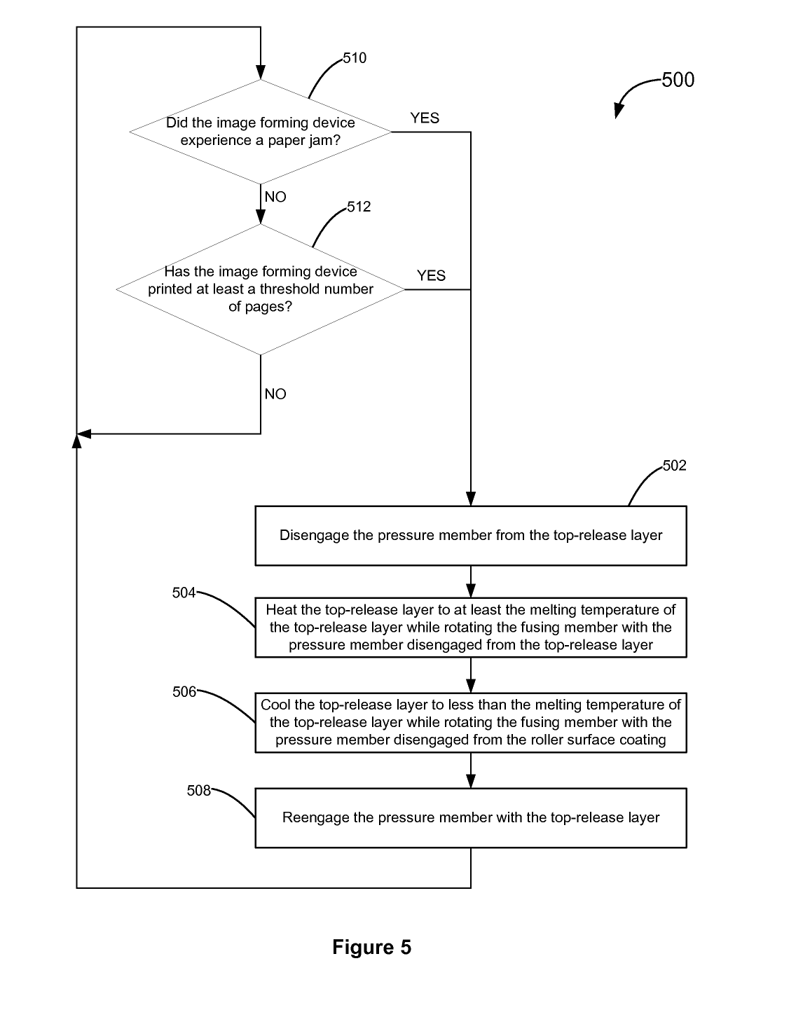

FIG. 5 shows an example embodiment of a method 500 of operating an image forming device using the present invention. The method of operating an image forming device restores uniform gloss to a top-release layer. The method utilizes an image forming device that has been configured to disengage and reengage a pressure member from the fusing-member top-release layer.

At block 502, the method 500 disengages the pressure member from the top-release layer.

At block 504, the method 500 heats the top-release layer to at least the melting temperature of the top-release layer while rotating the fusing member with the pressure member disengaged from the top-release layer. Heating the top-release layer to at least its melting temperature causes it to flow and heal gloss imperfections such as scratches or gloss bands. Since, at block 504, no pressure member engages the top-release layer, the top-release layer is free to flow without disturbance from pressure members. Such disturbances may create non-uniformities in the top-release layer which may cause print defects.

At block 506, the method 500 cools the top-release layer to less than the melting temperature of the top-release layer while rotating the fusing member with the pressure member disengaged from the roller surface coating. Rotating the fusing member prevents the top-release layer from sagging due to gravity.

At block 508, the method 500 reengages the pressure member with the top-release layer. Once the pressure member is reengaged with the top-release layer, the fuser is ready to fuse toner to media.

At block 510, a determination is made to see if the image forming device experienced a paper jam. If it did, the method proceeds to block 502. During a paper jam, residual heat from a lamp may transfer unevenly to the top-release layer due to paper partially blocking the top-release layer. This uneven heating may cause a gloss band that may cause a print defect. In block 502, 504, 506, and 508, the method conditions the top-release layer to cure the gloss band.

At block 512, a determination is made to see if the image forming device has printed at least a threshold number of pages. If it did, the method proceeds to block 502. The threshold number of pages may correspond to when wear on the top-release layer is expected to start causing print defects. Conditioning the top-release layer may prevent these print defects.

Note that, in image forming device 22 shown in FIG. 1, controller 28 may be configured to perform one or more methods of the invention. For example, controller 28 may be configured to condition the top-release layer by disengaging the pressure member from the top-release layer, heating the top-release layer to at least the melting temperature of the top-release layer while rotating the fusing member with the pressure member disengaged from the top-release layer, cooling the top-release layer to less than the melting temperature of the top-release layer with the pressure member disengaged from the top-release layer, and reengaging the pressure member with the top-release layer. In this example, controller 28 controls activation of lamp 212, the motor coupled to shaft 204, and the mechanism that disengages belt 216 from top-release layer 210, via communications link 58.

Controller 28 may be further configured to condition the top-release layer automatically after detecting that the image forming device experienced a paper jam. Controller 28 may be configured to condition the top-release layer automatically after detecting that the image forming device has printed at least a threshold number of pages. Controller 28 may automatically condition the top-release layer upon detecting either a threshold number of pages or upon detecting a paper jam, or controller 28 may only look for one of these events. Alternatively, controller 28 may be configured to condition the top-release layer upon receiving a user input.

The foregoing description of several embodiments has been presented for purposes of illustration. It is not intended to be exhaustive or to limit the application to the precise forms disclosed, and obviously many modifications and variations are possible in light of the above teaching. It is understood that the invention may be practiced in ways other than as specifically set forth herein without departing from the scope of the invention. It is intended that the scope of the application be defined by the claims appended hereto.

1. A method of operating an image forming device, the image forming device includes a fusing member having a top-release layer and a pressure member configured to engage the top-release layer, the method comprising:
disengaging the pressure member from the top-release layer;
heating the top-release layer to at least a melting temperature of the top-release layer while rotating the fusing member with the pressure member disengaged from the top-release layer;
cooling the top-release layer to less than the melting temperature of the top-release layer while rotating the fusing member with the pressure member disengaged from the roller surface coating; and
reengaging the pressure member with the top-release layer.

2. The method of claim 1, wherein heating the top-release layer comprises heating the top-release layer to between 310 and 325 degrees Celsius, inclusive, for between 30 and 180 seconds, inclusive, and the top-release layer contains perfluoroalkoxy.

3. The method of claim 1, wherein heating the top-release layer comprises heating the top-release layer to between 315 and 320 degrees Celsius, inclusive, for between 60 and 90 seconds, inclusive, and the top-release layer contains perfluoroalkoxy.

4. The method of claim 1, further comprising detecting that the image forming device experienced a paper jam; wherein the disengaging the pressure member, the heating the top-release layer, the cooling the top-release layer, and the reengaging the pressure member occur automatically after detecting that the image forming device experienced the paper jam.

5. The method of claim 1, further comprising detecting that the image forming device has printed at least a threshold number of pages; wherein the disengaging the pressure member, the heating the top-release layer, the cooling the top-release layer, and the reengaging the pressure member occur automatically after detecting that the image forming device has printed at least the threshold number of pages.

6. A method of conditioning a fusing member having a top-release layer, the method comprising:
heating the top-release layer to at least a melting temperature of the top-release layer while rotating the fusing member and while no pressure member engages the top-release layer; and
cooling the top-release layer to less than the melting temperature of the top-release layer while rotating the fusing member.

7. The method of claim 6, wherein heating the top-release layer comprises heating the top-release layer to between 310 and 325 degrees Celsius, inclusive, for between 30 and 180 seconds, inclusive, and the top-release layer contains perfluoroalkoxy.

8. The method of claim 6, wherein heating the top-release layer comprises heating the top-release layer to between 315 and 320 degrees Celsius, inclusive, for between 60 and 90 seconds, inclusive, and the top-release layer contains perfluoroalkoxy.

9. An image forming device, comprising:
a fusing member having a top-release layer;
a pressure member configured to engage with the top-release layer to press media against the top-release layer; and
a controller configured to condition the top-release layer by disengaging the pressure member from the top-release layer, heating the top-release layer to at least a melting temperature of the top-release layer while rotating the fusing member with the pressure member disengaged from the top-release layer, cooling the top-release layer to less than the melting temperature of the top-release layer with the pressure member disengaged from the top-release layer, and reengaging the pressure member with the top-release layer.

10. The image forming device of claim 9, wherein the top-release layer contains perfluoroalkoxy.

11. The image forming device of claim 9, wherein the controller is configured to condition the top-release layer automatically after detecting that the image forming device experienced a paper jam.

12. The image forming device of claim 9, wherein the controller is configured to condition the top-release layer automatically after detecting that the image forming device has printed at least a threshold number of pages.
